(19) United States
(12) Patent Application Publication
(10) Pub. No.: US 2002/0093414 A1
(43) Pub. Date: Jul. 18, 2002

(54) Patterned ground shield for mirror current elimination

(75) Inventors: Shyh-chyi Wong, Hsinchu (TW); Chiung-Ting Ou, Hsinchu (TW)

Correspondence Address: FINNEGAN, HENDERSON, FARABOW, GARRETT &, DUNNER LLP, 1300 I STREET, NW, WASHINGTON, DC, 20005, US

(73) Assignee: Winbond Electronics Corporation

(21) Appl. No.: 09/760,671

(22) Filed: Jan. 17, 2001

(51) Int. Cl. H01F 5/00

(52) U.S. Cl. 336/200

(57) ABSTRACT

A semiconductor device including a substrate, a polysilicon shield layer having a plurality of dielectric sections disposed over the substrate and the plurality of dielectric sections being of a geometric shape, and an inductor including a first metallic layer disposed over the polysilicon layer wherein the first metallic layer overlaps a number of the plurality of dielectric sections and each of the plurality of dielectric sections is of a proximity from one another to substantially reduce or prevent mirror current from being formed in the shield layer.

### BACKGROUND OF THE INVENTION

1. Field of the Invention

This invention pertains in general to a semiconductor device having an on-chip inductor and, more particularly, to a ground shield, positioned between the inductor and silicon substrate, patterned for mirror current reduction or elimination.

2. Description of the Related Art

On-chip inductors are generally required for radio frequency (“RF”) integrated circuits (“ICs”), and spiral on-chip inductors are preferred in high frequency applications. As disclosed in “On-Chip Spiral Inductors with Patterned Ground Shields for Si-Based RF IC's,” by Yue et al., IEEE (1998), inductor quality factor (Q) for RF ICs degrades at high frequencies because of energy dissipation in the semiconductor substrate. The energy dissipation may be attributed to inductor- generated magnetic flux, which induces current in the semiconductor substrate and dissipates the energy of the inductor. Therefore, various techniques have been devised to reduce or eliminate such energy dissipation, or decouple inductors from the semiconductor substrate.

Yue et al. describes forming a patterned ground shield on a polysilicon layer disposed between an on-chip inductor and the semiconductor substrate. The patterned ground shield includes a plurality of slots orthogonal to the spiral of the inductor. More particularly, the slots are positioned perpendicular to the direction of a mirror current induced in the shield by the magnetic fold of the inductor and act as an open circuit to interrupt the path of the mirror current induced in the ground shield. In order to maintain the conductivity of the polysilicon layer, however, the slots must be sufficiently narrow. In view of the extensive network of slots described by Yue et al., such a requirement may not be practical in view of available photolithography and etching techniques.

### SUMMARY OF THE INVENTION

Accordingly, the present invention is directed to a patterned ground shield that substantially obviates one or more of the problems due to limitations and disadvantages of the related art.

Additional features and advantages of the invention will be set forth in the description which follows, and in part will be apparent from the description, or may be learned by practice of the invention. The objectives and other advantages of the invention will be realized and attained by the structures and methods particularly pointed out in the written description and claims thereof, as well as the appended drawings.

To achieve these and other advantages, and in accordance with the purpose of the invention as embodied and broadly described, there is provided a semiconductor device having a patterned ground shield disposed between an on-chip inductor and a semiconductor substrate to substantially suppress mirror current in the semiconductor substrate. The semiconductor device includes the substrate and the patterned ground shield comprised of a polysilicon layer having a plurality of dielectric sections, each section having a geometric shape. The polysilicon layer is disposed over the substrate. The inductor includes a first metallic layer disposed over the polysilicon layer, wherein the first metallic layer overlaps at least one of the plurality of dielectric sections. The plurality of dielectric sections are arranged to substantially suppress a mirror current from being formed in the polysilicon layer.

In one aspect of the invention, the dielectric sections are arranged in a spiral formation.

In another aspect, the dielectric sections are substantially rectangular.

In yet another aspect, the dielectric sections extend at least 20 microns beyond a periphery of the first metallic layer of the inductor.

Also in accordance with the invention, there is provided a semiconductor device that includes a substrate, a polysilicon layer, having a plurality of dielectric sections, disposed over the substrate, the plurality of dielectric sections being of a geometric shape and defining a first area, and a first metallic layer disposed over the polysilicon layer defining a second area wherein the second area overlaps the first area and the second area is smaller than the first area and wherein the polysilicon layer substantially eliminates a mirror current in the polysilicon layer. The semiconductor device further includes a second metallic layer disposed over the first metallic layer, and a via connecting the first metallic layer and the second metallic layer.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are incorporated in and constitute a part of this specification, illustrate embodiments of the invention and, together with the description, serve to explain the objects, advantages, and principles of the invention.

In the drawings:

FIG. 1 illustrates a plan view of one embodiment of a patterned ground shield of the present invention;

FIG. 2 illustrates a plan view of another embodiment of the patterned ground shield of the present invention; and

FIG. 3 is cross-sectional view of the patterned ground shield of the present invention as disposed between a semiconductor substrate and an inductor.

### DETAILED DESCRIPTION OF THE PREFERRED EMBODIMENTS

In accordance with the present invention, there is provided a patterned ground shield disposed between an on-chip inductor and a semiconductor substrate to substantially reduce or eliminate mirror current in the semiconductor substrate.

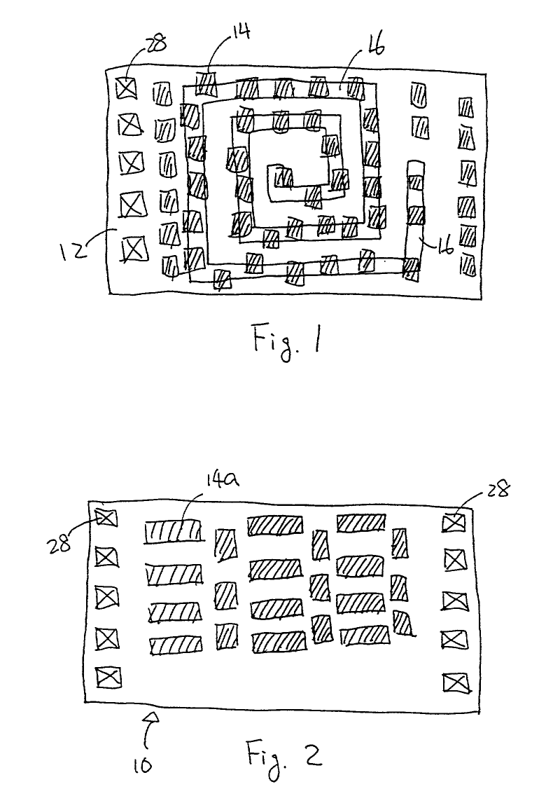

FIG. 1 illustrates a plan view of an embodiment of the patterned ground shield of the present invention. Referring to FIG. 1, a patterned ground shield 10 includes a polysilicon layer 12 disposed therein having a plurality of dielectric sections 14 of a geometric shape, preferably rectangular. Dielectric sections 14 may be composed of spacer oxide or inter-layer dielectric materials, and preferably should be no thicker than that of polysilicon layer 12. An inductor layer 16 is disposed over polysilicon layer 12 and dielectric sections 14. As shown in FIG. 1, inductor layer 16 overlaps a number of dielectric sections 14, the number of overlapped sections depending on the density of dielectric sections 14 disposed in polysilicon layer 12. The density of dielectric sections 14, in turn, depends on the proximity of dielectric sections to one another. Importantly, the proximity must be such that patterned ground shield 10 is able to substantially reduce or eliminate mirror current in ground shield 10, while at the same time maintaining the conductivity of polysilicon layer 12 so that it effectively performs its shielding function. In a preferred embodiment, dielectric sections 14 are as close to one another as the design rules of the device in which patterned ground shield 10 is disposed will permit.

In another preferred embodiment, dielectric sections 14 are arranged in a spiral formation. Conceptually, the spiral formation of dielectric sections 14 resembles the top view of a two-dimensional representation of a “beehive”.

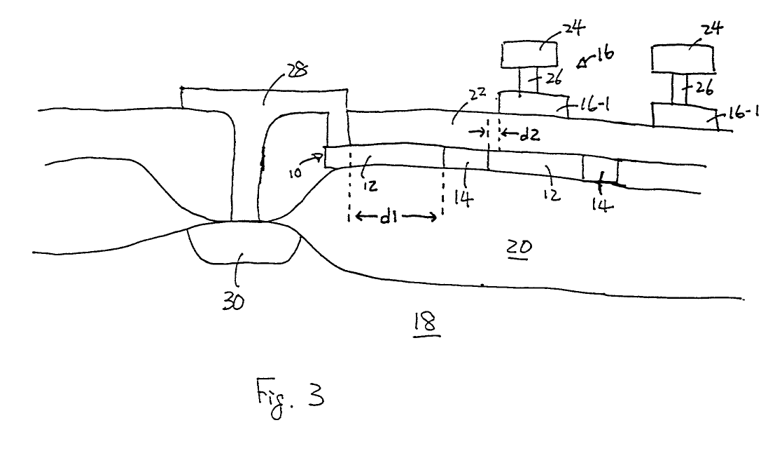

FIG. 2 illustrates a plan view of another preferred embodiment of the present invention. In FIG. 2, unlike FIG. 1, the inductor layer is not shown. Referring to FIG. 2, ground shield 10 includes dielectric sections 14a that are substantially rectangular in shape and are arranged in alternate orientations. With ground shield 10 oriented as shown in FIG. 2, dielectric sections 14a are arranged in columns with the long side of the rectangles in each column being rotated approximately 90° relative to the long side in the adjacent rows.

FIG. 3 is cross-sectional view of patterned ground shield 10 of the present invention as disposed between a semiconductor substrate and an inductor. Referring to FIG. 3, there includes a substrate 18 having element isolation a spaced-apart region 30 for an active device, such as a source or drain region of a transistor (not shown). The process of forming an inductor generally begins after active devices already have been formed. A layer of field oxide 20 is formed over substrate 18. Patterned ground shield 10 of the present invention is disposed over field oxide 20.

Patterned ground shield 10 may be formed by first forming polysilicon layer 12 and then depositing a mask layer, over polysilicon layer 12, with geometric-shaped, e.g., rectangular, openings in a desired pattern. This structure is then etched to form openings in polysilicon layer 12 in correspondence with the openings in the mask layer. After the mask layer is removed, the openings in polysilicon layer 12 are then filled with a selected dielectric material such as a spacer oxide. Alternatively, an inter-layer dielectric layer is deposited on polysilicon layer 12 to fill in the openings to thereby form dielectric sections 14 as well as the inter-layer dielectric layer. In another preferred embodiment, dielectric sections 14 extend at least 20 microns beyond in all directions of a boundary defined by the periphery of inductor layer 16 to ensure that dielectric sections 14 be placed and extend to the region near substrate contacts 28 (FIG. 3) and to compensate for expansion of the flux-induced magnetic field. As shown in FIG. 3, the distance d1 between dielectric section 14 and substrate contact 28 is greater than 20 microns. In other words, dielectric sections 14 define a first area, and inductor layer 16 defines a second area. It is preferred that the first area be greater than the second area. Referring to FIG. 3, the distance d1 between one of the inductor layers 16 and one of the dielectric sections 14 is smaller than 5 microns.

Disposed over patterned ground shield 10 is an inter-layer dielectric (“ILD”) 22. ILD layer 22 can be composed of undoped tetraethyl orthosilicate (“TEOS”), borophosphosilicate glass (“BPSG”) and plasma enhanced tetraethyl orthosilicate (“PETEOS”). Alternatively, ILD layer 22 may be composed of plasma enhanced silane oxide. An on-chip inductor is disposed over ILD 22. The inductor (not numbered) can be formed with conventional methods and includes a plurality of first metallic sections 16-1, formed in the spiral pattern shown in FIG. 1, a plurality of second metallic sections 24 above sections 16-1 and also formed in a spiral pattern, and vias 26, or interconnects, that connect first metallic sections 16-1 and second metallic sections 24. Metallic sections 16-1 and 24 can be composed of a conventional metallic material, such as aluminum (Al) or copper (Cu). Suitable materials for vias 26 include tungsten (W), aluminum (Al), or copper (Cu). In addition, the metallic sections 16-1 and 24 are separated by an inter-metal dielectric (not shown). Substrate contact 28 connects spaced apart region 30, such as a source or drain of a transistor (not shown), to establish an ohmic contact with polysilicon layer 12 of patterned ground shield 10.

It will be apparent to those skilled in the art that various modifications and variations can be made in the disclosed process and product without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A semiconductor device, comprising:
a substrate;
a polysilicon layer, having a plurality of dielectric sections, disposed over said substrate, said plurality of dielectric sections each being of a geometric shape; and
an inductor including a first metallic layer disposed over said polysilicon layer, wherein said first metallic layer overlaps at least one of said plurality of dielectric sections and said plurality of dielectric sections are arranged to substantially suppress a mirror current from being formed in said polysilicon layer.

2. The semiconductor device as recited in claim 1 wherein said dielectric sections are arranged in a spiral formation.

3. The semiconductor device as recited in claim 1 wherein each of said dielectric sections is substantially rectangular.

4. The semiconductor device as recited in claim 3 wherein successive alignments of said rectangular-shaped dielectric sections alternate in orientation.

5. The semiconductor device as recited in claim 1 wherein said dielectric sections extend at least 20 microns beyond a periphery of said first metallic layer of said inductor.

6. A semiconductor device, comprising:
a substrate;
a polysilicon layer, having a plurality of dielectric sections, disposed over said substrate, said plurality of dielectric sections being of a geometric shape and defining a first area;
a first metallic layer disposed over said polysilicon layer defining a second area wherein said second area overlaps said first area and said second area is smaller than said first area and wherein said polysilicon layer substantially eliminates a mirror current in said polysilicon layer;
a second metallic layer disposed over said first metallic layer; and
a via connecting said first metallic layer and said second metallic layer.

7. The semiconductor device as recited in claim 6 wherein said dielectric sections are arranged in a spiral formation.

8. The semiconductor device as recited in claim 6 wherein each of said dielectric sections is substantially rectangular.

9. The semiconductor device as recited in claim 8 wherein successive alignments of said rectangular-shaped dielectric sections alternate in orientations.

10. The semiconductor device as recited in claim 6 wherein said dielectric sections extend at least 20 microns beyond a periphery of said second area.

11. The semiconductor device as recited in claim 6 further comprising a BPSG layer disposed between said polysilicon layer and said first metallic layer.
